(19) United States
(12) Patent Application Publication
(10) Pub. No.: US 2003/0149597 A1
(43) Pub. Date: Aug. 7, 2003

(54) System for supporting clinical decision-making

(76) Inventor: John R. Zaleski, West Brandywine, PA (US)

Correspondence Address: Siemens Corporation, Intellectual Property Department, 186 Wood Avenue South, Iselin, NJ, 08830, US

(21) Appl. No.: 10/313,532

(22) Filed: Dec. 6, 2002

Related U.S. Application Data
(60) Provisional application No. 60/347,267, filed on Jan. 10, 2002.

(51) Int. Cl. G06F 17/60; G06F 7/00; G06F 17/30

(52) U.S. Cl. 705/2; 705/3; 707/3

(57) ABSTRACT

The invention is directed to a system that uses a repository of patient medical records in supporting clinical decision making, and which incorporates receiving, from a first source, data representing an order associated with treatment of a medical condition; interpreting the order to determine search criteria for use in identifying records related to the patient medical condition; searching a database of patient medical records based on the search criteria; identifying, in the patient medical record database, information concerning different treatments previously employed for treating the medical condition based on the search criteria; and providing the different treatment information to the first source.

This is a non-provisional application of provisional application serial No. 60/347,267 by Dr. J. Zaleski filed Jan. 10, 2002.

### BACKGROUND

1. Field of the Invention

The invention relates to system for supporting clinical decision-making, and more particularly to a computer-implemented system for automatic workflow control to support clinical decision-making.

2. Description of the Prior Art

Clinical decision-making involves selecting the appropriate action to be taken for diagnosing and treating patients while remaining fully aware of and weighing, the alternate approaches and risks associated with these diagnostic and treatment processes. Because selection of treatment involves the weighing of risks, and because all information (such as underlying causes) may not be known, there is uncertainty involved in the process of making clinical decisions. Consequently, attempts are often made to quantify and constrain the effect of making clinical decisions in an effort to reduce this uncertainty. This has the effect of providing a quantitative understanding of the likelihood of success or failure, as well as the consequences associated with making various clinical decisions. A number of systems exist in the prior art to perform data mining, trend extraction, and to determine some relationships in data. However, these systems typically use data at an administrative level to evaluate trends across large populations and do not support trending and feedback of data.

In addition, in the healthcare context, for example, available data mining tools provide static assessments of data and fail to provide a temporal assessment of data with feedback from current patients (e.g., such a tool does not allow a physician to automatically and directly add a new patient to the data pool). Systems also exist that provide, on a weekly basis, a summary of the orders on any given patient. However, such systems fail to (1) automatically feedback statistics on patients to the physician, or, (2) use statistics to feedback process control information (that is, similarity in treatment and diagnoses on classes of patients).

Accordingly, with quality control and assurance being increasingly scrutinized, particularly in patient care, as cost cutting measures and the need to reduce medical errors continues, a system is needed that is capable of maintaining physician orders, providing statistics on their use for future diagnoses on patients, and providing feedback to physicians on the orders generated on patients so as to identify those cases in which deviations occur in patient treatment and diagnosis.

### SUMMARY OF THE INVENTION

Embodiments of the invention include systems that use a repository of patient medical records in supporting clinical decision making, and which incorporate receiving, from a first source, data representing an order associated with treatment of a medical condition; interpreting the order to determine search criteria for use in identifying records related to the patient medical condition; searching a database of patient medical records based on the search criteria; identifying, in the patient medical record database, information concerning different treatments previously employed for treating the medical condition based on the search criteria; and providing the different treatment information to the first source.

### BRIEF DESCRIPTION OF THE DRAWINGS

FIG. 1(a) is a diagram of an apparatus used in a preferred embodiment of the invention.

FIG. 1(b) is a computer screenshot of a user interface in a preferred embodiment of the invention.

FIG. 2 is a flow chart of the operation of a preferred embodiment of the invention.

FIG. 3 is a data histogram showing comparisons between inpatient age distributions for various patient data populations in an example using a preferred embodiment.

FIG. 4 is a data histogram showing comparisons between inpatient charge distributions for various patient data populations in an example using a preferred embodiment.

FIG. 5 is a chart illustrating a comparison between inpatient and outpatient charges, showing a 1-sigma standard deviation for five breast biopsy diagnoses in an example using a preferred embodiment.

FIG. 6 is a chart illustrating the cumulative distribution curves for five diagnoses from breast biopsies in an example using a preferred embodiment.

FIGS. 7(a)-(b) are charts illustrating a cumulative charge distribution for Cystic Mastopathy inpatients and outpatients in an example using a preferred embodiment.

### DETAILED DESCRIPTION

The invention will be understood more fully from the detailed description given below and from the accompanying drawings of preferred embodiments of the invention; which, however, should not be taken to limit the invention to a specific embodiment but are for explanation and understanding.

The embodiments of the invention described herein incorporate a system built upon patient accounting and clinical data, accompanying methodology, and embedded analytical functions for providing investigators, such as physicians, with feedback on orders written on patients in order to characterize the degree to which patients within their care are being treated in a manner similar to other patients receiving the same or similar diagnoses.

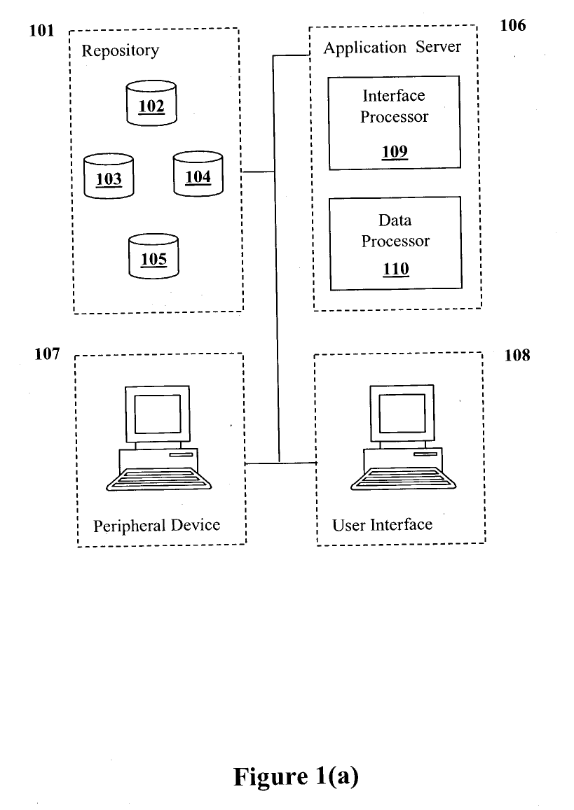

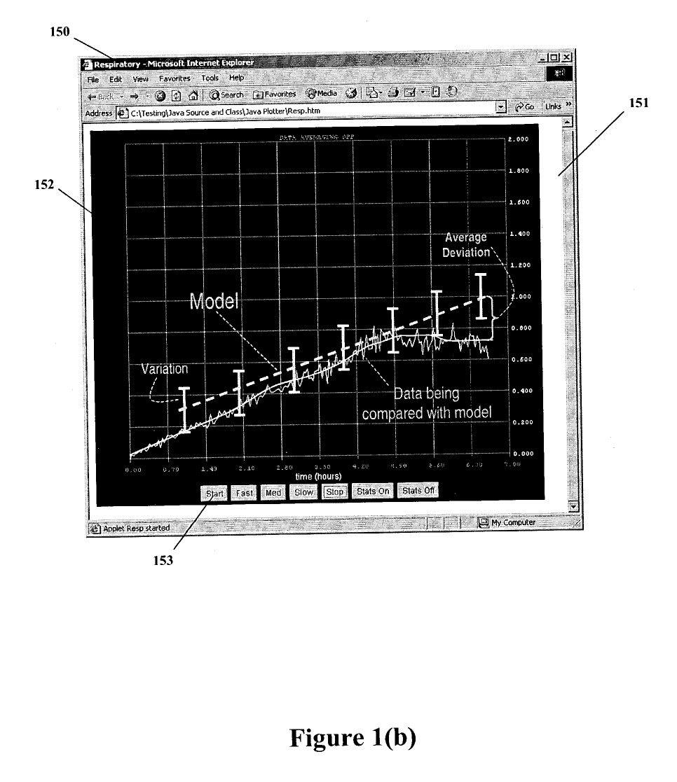

FIG. 1(a) is a diagram of a preferred embodiment of an apparatus used in the invention. This embodiment is preferably implemented in computer hardware and software configured to operate in the manner of the invention, embodiments of which are described herein. Those of ordinary skill in the art will appreciate that the embodiment of the system shown here is provided with the intent of demonstrating a clear understanding of the potential capabilities of the system and not to limit the scope or possible embodiments of the invention.

The embodiment shown in FIG. 1(a) includes a data Repository (101), which may include, as one embodiment, a plurality of data repositories for different types of data, such as Patient Training Data Repository (102), a Statistical Training Data Repository (103), Patient Testing Data Repository (104), and Training/Test Comparison Repository (105). These data repositories may comprise any of a number of data storage systems that are well known to those of skill in the art, such as one or more relational databases, including SQLServer 2000, Oracle, DB2, or Microsoft Access.

The system may also include Application Server (106) containing software processes (e.g., programming code) capable of performing in accordance with the invention. The terms “computer”, “computer system”, or “server” as used herein should be broadly construed to include any device capable of receiving, transmitting and/or using information including, without limitation, a processor, microprocessor or similar device, a personal computer, such as a laptop, palm PC, desktop, workstation, or word processor, a network server, a mainframe, an electronic wired or wireless device, such as for example, a telephone, an interactive television, such as for example, a television adapted to be connected to the Internet or an electronic device adapted for use with a television, a cellular telephone, a personal digital assistant, an electronic pager, a digital watch and the like. Further, a computer, computer system, or system of the invention may operate in communication with other systems over a communication network, such as, for example, the Internet, an intranet, or an extranet, or may operate as a stand-alone system. The system of the invention may be deployed using other means computer-based or otherwise, such as for example, thin client applications, and may be deployed over a closed network, virtual private network, and any other internetworked system.

The initial receipt of the data by the system and output of information therefrom is preferably accomplished either manually or automatically through the use of hardware and software peripheral devices, as shown by example in FIG. 1(a) as Peripheral Device (107) and User Interface (108), which provide information to and from Application Server (106) using Interface Processor (109). Peripheral Devices (107) and User Interfaces (108) may communicate with Application Server (106) in any number of ways well known to those of ordinary skill in the art, such as through the use of conventional interface electrical cabling between the system of the invention and hardware/software modalities.

For example, any number of medical devices such as mechanical ventilators and intravenous pumps may communicate via serial port connections. These connections may be activated through software that retrieves data directly from the serial port or through terminal emulators. Additionally, hardware that translates the serial protocols to internetworking protocols (including Ethernet) is presently available. The benefit of this latter internetworking approach is scalability: being able to network many such devices into Repository (101), thereby enabling the retrieval of more data and facilitating connection to medical devices and the health information system.

The software for supporting the extraction of the data per specific modality is preferably stored locally within the system, such as on Application Server (106), and is applied to each specific modality as needed to extract the data. While capable of being processed in any form, the data is preferably converted by the peripheral devices into information contained within an Extensible Markup Language (XML) format, received by Application Server (106) and stored within Repository (101) using Data Processor (110). Alternatively, Application Server (106) could receive this information in its native format and convert it to XML.

During the clinical decision-making process, an investigator, such as a physician, attempts to form hypotheses regarding the outcome of experiments via the application of the scientific method: through experimentation, observation, analysis, and the drawing of conclusions. When conclusions are drawn, the details of the process by which those conclusions (results) were achieved are recorded so that others can attempt to reproduce the experiment and learn from the prior experiment as to the expected nature of the outcome.

If the results of a new experiment do not align with the previous results, then the investigator typically questions whether the reproduced experiment was conducted in a manner true to the previous or initial result, whether the old result was in error owing to some intrinsic flaw, or whether a certain amount of unanticipated uncertainty inherent in the experiment could have been of sufficient magnitude to allow a differing result. In the first two cases, the integrity of the experiment is in question. In the latter case, the quantity of data required to achieve a stable (or normal) result is in question and of particular importance in terms of ascertaining the most likely outcome of the experiment.

Of particular note, when comparing results of one patient with those of a collection, or sampling, of similar patients, the investigator should address whether the class of patients is sufficiently representative of this one patient, and whether the experiment (i.e., tests or resulting diagnosis, or both) are within the statistical sample space of the larger class of patients. If the latter is true, then the question is whether the patient's clinical features are represented accurately by the sample, and are the observed results significant in terms of establishing an accurate estimate of the outcome for the patient.

For example, if a physician is treating a patient diagnosed with fibrocystic disease, based on a larger population of female fibrocystic patients in the patient's age group, what is the likelihood that the patient will need to be admitted for further study; what are the treatment approaches for patients in the patient's class (translated into orders), and what are the normal range of charges for this particular class of patient?

In a preferred embodiment of the invention an automatic control workflow is used to compare results obtained from data computed in a reference model (i.e., an expected behavior model based on historical record) with test data for the particular patient under examination. In a typical workflow sequence, a physician, upon examining a patient, submits orders for patient diagnostic testing, which may be entered through user interface (108), for example, and stored in Repository (101). The orders are carried out in accord with the physician's prescription. Results of the diagnostic testing are provided as output back to the physician for analysis and are captured within the patient's record. Results of these tests may beget more results, such as through a workflow feedback to the physician. As a result of examination, the physician may prescribe additional testing. Simultaneously, historical data associated with either other similar patients within this physician's care or other patients having similar procedures may be compared with the results of this patient, indicating whether significant deviations exist between this patient and the larger population. In this way, the physician has access to both previous records of his or her patients and to a larger population with which to evaluate and scrutinize the quality of patient care, and to affirm present orders in light of past history.

Thus, data representing an order associated with treatment of a medical condition is received from a data source or repository; the order is interpreted to determine search criteria for use in identifying records related to the patient medical condition; a database or repository of patient medical records is searched based on the search criteria; information concerning different treatments previously employed for treating the medical condition based on the search criteria is identified in the patient medical record database; and the different treatment information is provided to the first source. The different treatment information may be formatted and displayed via a reproduction device, for example, such as via user interface (108).

The information concerning different treatments preferably includes resource consumption characteristic information concerning the different treatments, so that the resource consumption characteristics concerning treatment for a particular patient may be compared with corresponding resource consumption characteristics for the different treatments. These resource consumption characteristics may include, for example, financial cost of a treatment or course of treatment, quantity of medicine, number of nursing hours, number of physician hours, cost of equipment usage, length of time equipment used, length of time of inpatient stay, duration of home care facility usage and cost of medicine.

While the type of order associated with treatment of the medical condition is not particularly limited, it may preferably include one or more of the following types: an order for a medical test to be made for a patient, an order for a pharmacological prescription for a patient, an order for a service to be performed for a patient, an order for a form of diagnostic imaging to be performed for a patient, an order for surgical treatment for a patient, and an order for a form of physiological therapy to be performed on a patient.

It is preferred that the patient medical record database or repository contains statistically analyzed and trend indicative accumulated medical parameter information associated with a plurality of medical conditions and collated according to patient type characteristics. Data may be also be stored in the database that includes at least one of patient treatment information and a record of an order, together with an associated date, where the data is preferably collated by treatment and diagnosis category to accumulate patient medical records for a population of patients.

The system of the invention may be used to further identify a previous order and associated date based on the search criteria in the patient medical record database, determine a difference between the identified previous order and the received order associated with treatment of the medical condition; and provide information indicating the order difference to the first source. It may also be used to analyze the different treatment information to determine a difference between at least one diagnosis and treatment associated with the order and corresponding previous diagnoses and treatments recorded for similar patients.

Thus, a preferred embodiment of a system incorporating the invention may preferably include Interface Processor (109) for receiving data representing an order associated with treatment of a medical condition from a first source, such as from Repository (101), Peripheral Device (107), or User Interface (108); a database of patient medical records such as patient testing data Repository (104). In addition, a data Processor (110) may be used for interpreting the order to determine search criteria for use in identifying records related to the patient medical condition, and for initiating search of the database of patient medical records based on the search criteria, to identify information concerning different treatments previously employed for treating the medical condition based on the search criteria, and providing the different treatment information to the first source. Data Processor (110) may also initiate a search of the database of patient medical records based on the search criteria to identify resource consumption characteristic information concerning treatment previously employed for treating the medical condition based on the search criteria and providing the resource consumption information to the first source.

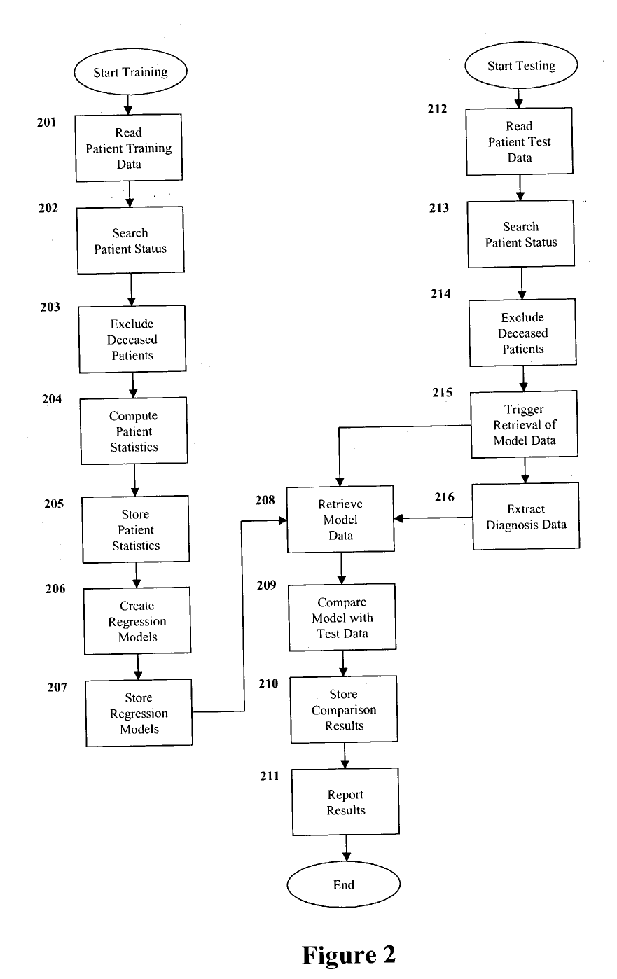

FIG. 2 is a flow chart illustrating an implementation of one preferred embodiment of an automatic control workflow. The reference model may be analyzed by receiving a sampling of patient training data for processing (201). This data may be stored in and retrieved from Patient Training Data Repository (102), for example, using Application Server (106). The system operating on Application Server (106) may search this data to determine the status of the patient's whose information is contained in the sample (202). For example, the data may be searched to determine which of the patients are inpatients, which are outpatients, and which are deceased. The data for patients who are deceased is preferably removed (203).

The system may compute a variety of relevant statistical information for the data (204), such as frequency distributions for age, fee charges, length of stay, etc. It may also calculate the average variance, mode, and percentile for this information. This information is then preferably stored (205), for example in a Statistical Training Data Repository (103). The patient data and statistical information may be used to create one or more regression models based upon this data (206), to be used in testing the specific data for the patient undergoing examination in order to make a clinical determination. The regression model data may also be stored (207), for example in Statistical Training Data Repository (103). Normal methods of data analysis might involve simple first and second order models (that is, those of the form y1=ax+b and y2=c+dx+ex², where: a, b, c, d, and e are constant coefficients determined according to the specific data in least-squares regression). However, other methods, such as Kalman and Batch Least Squares filtering are also enabled which allow for the tracking of measurements from observation to observation.

To start the testing process, specific patient data to be tested is obtained (212), such as from Patient Testing Data Repository (104). As with the patient training data, the patient testing data may be searched to determine the status of the patient or patients whose data is being tested (213). Again, the data may be searched to determine which of the patients are inpatients, which are outpatients, and which are deceased. The data for patients who are deceased is preferably removed (214).

The testing portion of the system then preferably triggers the retrieval of the appropriate regression model data for the test being performed (215), which causes Application Server (106) to retrieve the data (208), e.g., from Statistical Training Data Repository (103). The system also extracts specific diagnosis data from the patient testing data (216), which is compared to the statistical patient training data using the selected regression model (209). The results of this comparison are preferably stored (210), such as in Training/Test Comparison Repository (105). The system may also generate a report for these results (211) that the investigator (e.g., physician) may use in making a clinical decision regarding patient treatment. The results of this comparison may be used to reference differences between the historical reference model and the data for a specific patient.

As previously noted, data and results may be presented for viewing by the user via user interface (108). An example of such an interface is shown in FIG. 1(b). In this embodiment, user interface (108) may comprise Web Browser (150), having browser window (151) within which information may be displayed, such as through an interactive display image (152) generated by an applet downloaded as part of an HTML formatted Web page. The user may navigate or revise the manner of presentation of data by using function buttons (153). Of course, those of ordinary skill in the art will appreciate that this is only one example of how the information may be presented, others of which have been previously described above.

FIG. 1(b) contains an example comparison of current patient data with a priori information on similar classes of patients. Raw data are drawn in white. This data may represent any type of medical observation that is normally collected within the patient medical record. Overlaid on the data is a dashed green line that illustrates the most likely path based on past history of similar patients having like physiology and medical presentation, with yellow-barred variation lines identifying the density around the modeled value. The variation is user-selectable from the perspective of studying where this particular patient's measurements occur with respect to a large population. The yellow bars identify the patient measurement variation from the model mean. This variation could be assigned to a percentile—for instance: 95%. Then, given that this is the case in the example above, the first comparison measurement in the lower left-hand region of the graph illustrates that the patient's measurement occurs at a point outside of the 95^{th} percentile range below that average modeled value—a significant deviation for any one patient.

The advantages of the preferred embodiment of the invention may be seen from its application to a specific sampling of female breast biopsy patients taken from hospitals across the continental United States. This particular class of patient is exemplary because of the prevalence of breast disorders in female patients, and, therefore, the applicability of this embodiment to this patient population. Those of ordinary skill in the art will appreciate that this example is used for illustration of embodiments of the invention and that the invention is not limited thereto, but can be used for any type or manner of clinical support.

The data for this sampling was drawn from a repository of patient accounting and clinical data in the United States, consisting of accounting and clinical information from hospitals nationwide. The data contained the healthcare coded values for all diagnoses contained in the International Classification of Diseases (“ICD”). This data was used to develop predictive methods of the likelihood of particular diagnoses as a function of patient age, the length of stay, and the typical inpatient and outpatient charges associated with specific diagnosis classes and female patient age groups. ICD-9 and CPT-4 coded data samples available on both inpatients and outpatients was used in this example, but those of ordinary skill in the art will appreciate that the invention may just as well be used to aid in the prediction of events in larger patient populations, leading to general relationships between patient diagnoses and the likelihood of events for use by physicians in clinical decision support and administrative/healthcare planning for these patients.

The codes of particular interest used included ICD-9 diagnostic coded values ranging from 610-611 (disorders of the breast) and 174 (malignant neoplasm of the breast). Because this information is readily available on all patients in the sampling and conforms to a standard format, general methods may be defined to make use of this information for predictive purposes. The data used in the example disclosed herein includes female patient breast biopsy length of stay, charges, and age. In particular, the following diagnostic codes were considered in this example: ICD-9, codes 174.8, 174.9, malignant neoplasm of the female breast, excluding skin of breast (172.5, 173.5); ICD-9, code 217, benign neoplasm of the female breast, excluding adenofibrosis (610.2), benign cyst of breast (610.0), fibrocystic disease (610.1), and skin of breast (216.5); and ICD-9, code 610, benign mammary displasias.

In the case of the last diagnosis (benign mammary displasias), a benign condition typically affects approximately 50-60% of all women between the ages of 20 and 60. Furthermore, mastopathy is often found during palpation of the mammas, and in approximately 30-40% of women aged 20-40. However, it is reported that of those women who die from different causes, the dishormonal changes evident in women with mastopathies are found in approximately 60-80% of these women. Hence, finding ways of improving quality control for these patients, including identifying specific attributes that can enable more effective treatment, relates directly to improving that health of the vast majority of women today.

Patient training data of parameter characteristics was developed from the financial data associated with patient length of stay, age, and charges. The training data consisted of selecting a sub-portion of the overall data set, selected on a first-come, first-serve basis from the global set of data. This training data represented the charge, length of stay, inpatient and outpatient, and age characteristics of approximately 500 patients per diagnosis code.

This information was sorted by specific diagnosis code, and frequency distributions according to female patient age, length of stay, and the charges that were developed. From these sorted distributions, average and standard deviations in the parameter values were determined, and regression curves were created and stored that characterized the typical age, charging, and length of stay characteristics of the patients sorted by specific diagnosis.

The following assumptions were employed in the generation of the statistical data. The patient accounting (archive, inpatient, outpatient) data was the source of raw patient information. All patient data was de-identified per regulations promulgated under the Health Insurance Portability and Accountability Act of 1996 (HIPAA). The hospitals under consideration are general acute care facilities. Data are available from 1997 through the first half of 2001. At least 95% of the hospital's inpatient records pass the following patient screening criteria: a) data came from a hospital that met all of the basic screening criteria listed above; b) patient encounter was either an inpatient, emergency room (who was not then immediately admitted as an inpatient), or an outpatient; c) patient encounter was final billed at the time the data is extracted from operational files; and d) a patient encounter had charges greater than $0.00.

Once accomplished, the remaining patient data, or the test group, which was kept isolated from the training data, was evaluated using regression curve models determined from the training set, to determine the relative validity of the training data from the perspective of the application of these regression curves as homogeneous and generally representative of the test group. The resulting comparisons among charges and patient age were reported and the results are discussed in more detail below. The ICD-9 and CPT-4 charges, length of stay, and age data associated with 165,000 patients diagnosed with specific disorders of the breast were evaluated. The data were sorted according to most prevalent diagnosis code, and the data associated with those patients having the largest populations were considered. To further limit variability, the top five patient populations based on diagnosis were selected. The key financial and demographic data associated with these patients is shown below in Table 1.

TABLE 1
Top 5 breast biopsy diagnoses.

| | | | Average | | |
|---|---|---|---|---|---|
| ICD-9 | | | LOS | | |
| Diagnosis | | Total patients | (Length of | Average | Average |
| Code | Specific Diagnosis | with diagnosis | stay) | charges | age (years) |
| 610.1 | DIFFUS CYSTIC | 31118 | 0.12 | $2,965.38 | 51.9 |
| | MASTOPATHY | | | | |
| 217 | BENIGN NEOPLASM | 25747 | 0.10 | $2,948.55 | 44.6 |
| | BREAST | | | | |
| 174.8 | MAL NEOPL BREAST | 18393 | 1.36 | $7,208.70 | 60.4 |
| | NEC | | | | |
| 174.9 | MAL NEOPL BREAST | 12583 | 0.80 | $6,117.40 | 61.4 |
| | NOS | | | | |
| 611.72 | LUMP OR MASS IN | 10672 | 0.09 | $2,400.98 | 50.3 |
| | BREAST | | | | |

In order of population size, specific diagnoses included diffuse cystic mastopathy, including fibrocystic disease of the breast; benign neoplasm, malignant neoplasm, and both malignant and benign lumps or masses contained within the breast tissue. Population size ranged from approximately 31,000 patients (fibrocystic disease) to 10,600 (lump or mass in breast) for the five classes of diagnosis.

Table 2 summarizes the average and standard deviation statistics associated with patient age for these top five diagnoses. The selection of the sample size for training was performed empirically by determining the approximate minimum sample size required that asymptotically approached a fixed value in terms of distribution shape, average, and standard deviation.

TABLE 2
Training data statistics

| | | | | Sample |
|---|---|---|---|---|
| ICD-9 or | Parameter under | Number in | | Standard |
| CPT-4 Code | consideration | Training Set | Average | Deviation |
| 610.1 | Age | 500 | 51.4 | 13.33 |
| 217 | Age | 500 | 47.5 | 16.57 |
| 174.8 | Age | 500 | 60.4 | 13.77 |
| 174.9 | Age | 500 | 63.6 | 13.96 |
| 611.72 | Age | 500 | 52.4 | 14.08 |

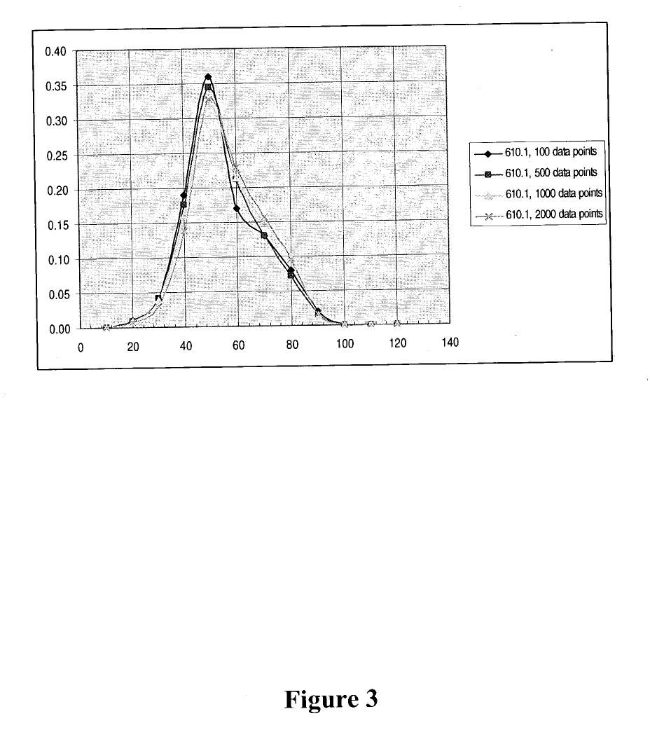

FIG. 3 is a chart that visually illustrates this empirical approach for estimating training sample size by comparing the frequency distributions associated with patient age for the ICD-9 610.1 disease code class of patients. FIG. 3 contains a comparison of the distribution curves associated with a sampling of 100, 500, 1000, and 2000 patients. The operating point of 500 patients was selected as the frequency distribution curve associated with this sampling approximated in form those of the 1000 and 2000 data point sample more closely.

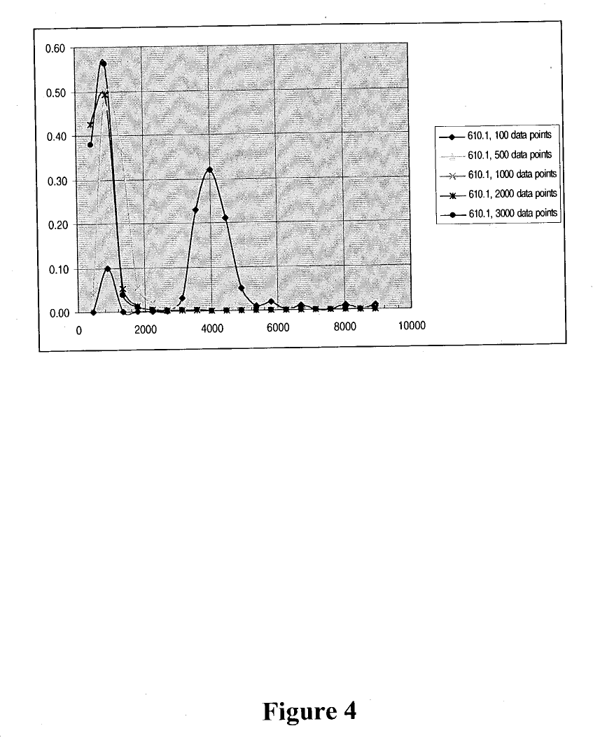

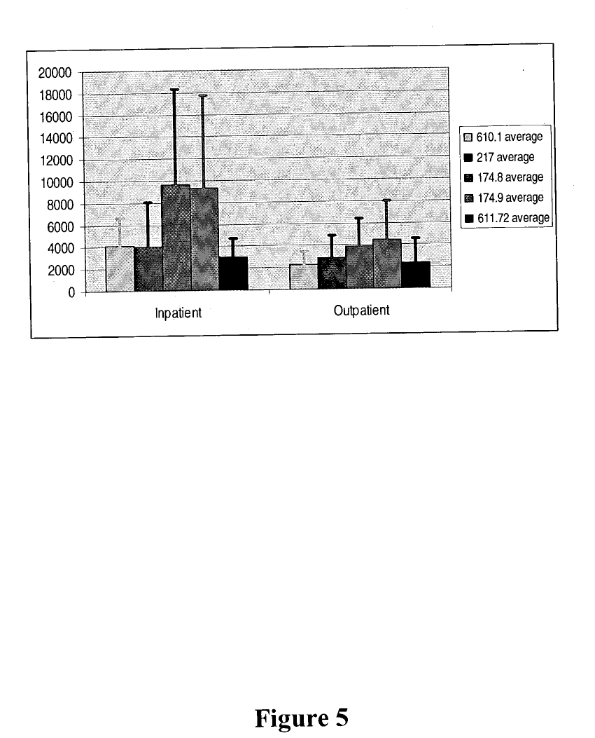

In studying the charges associated with a patient stay, a careful distinction should be placed on whether the patient has been admitted or is being treated as an outpatient. By collecting both inpatients and outpatients together in a distribution, the effect of a bimodal distribution can be seen. This is illustrated in FIG. 4. The dual-humped distribution results from the inclusion of both inpatients and outpatient in the charge sample. Therefore, to obtain more accurate assessments of both inpatients and outpatients, charges should preferably be separated into distinct categories of inpatient and outpatient. By separating these two categories, a distinction can be seen between inpatients and outpatients across the five disease categories. This is illustrated in FIG. 5. The bars shown in FIG. 5 represent the average values and the error markers are representative of the one-sigma sample standard deviation.

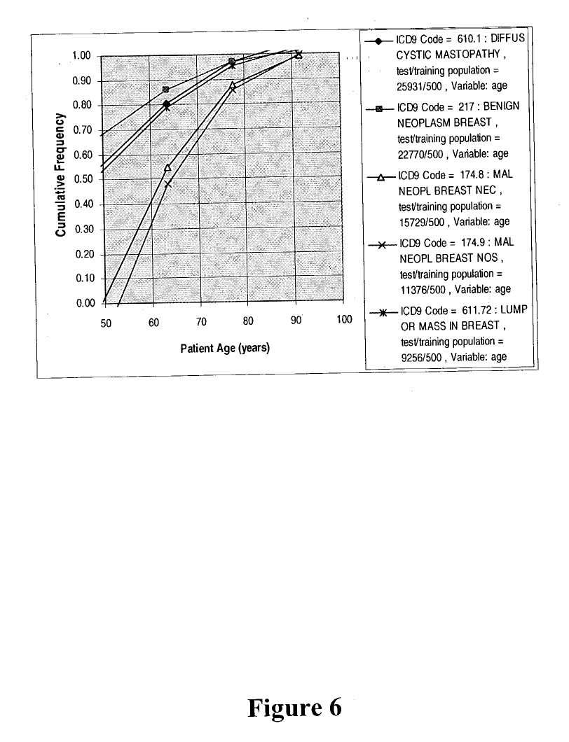

FIG. 6 illustrates the results of the method of the preferred embodiment using patient age as the parameter of interest. In each case, the training data was derived from 500 patients. The average and variance was then applied to determine the percentile associated with a larger set of patients contained within a test group per diagnostic code. A regression curve was created defining the quantity of patients diagnosed with a specific ICD-9 code-based illness as a function of age. The regression curves developed from the training samples were then used to test hypothetically a test sample set for each ICD-9 diagnosis class of patients. As previously shown, since the statistics of the distributions associated with the sample set for 500 patients provides a close approximation to the statistics of the larger sample set, it is possible to use this information as a predictor for behavior. So, looking at the ICD-9 code 610.1 (Diffuse Cystic Mastopathy) curve in FIG. 6, it may be determined that, for example, approximately 80% of patients diagnosed with this particular breast ailment from breast biopsy examinations are under the age of 60 years, whereas fewer that 40% of patients diagnosed with ICD-9 codes 174.8 or 174.9 (Malignant Neoplasm of the Breast) are under the age of 60 years.

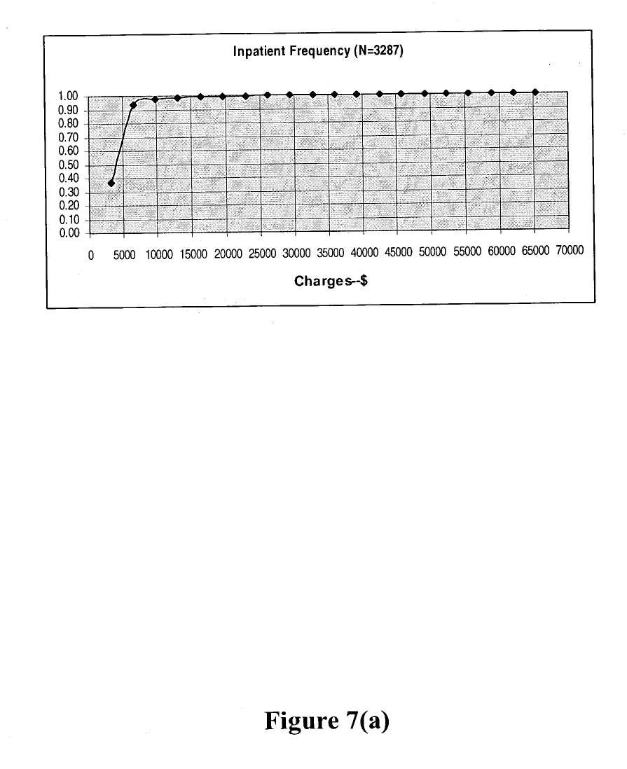

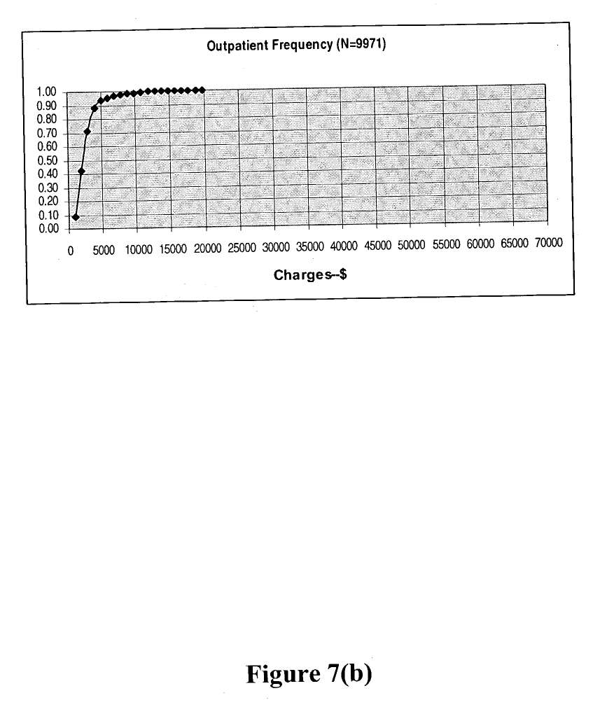

This information, when combined with the data of FIG. 5, provides information on the characteristics of the examination and charging process associated with patients within these classes. FIG. 7(a) shows the cumulative charge distribution for Cystic Mastopathy patients admitted as inpatients in the example sampling. In contrast, FIG. 7(b) shows the outpatient charge distribution for these patients. In the case of the outpatient data, over 90% of the charges are less than $5,000. In the case of inpatients, approximately $6,000-$7,000 per patient is found. In addition, the range of the inpatient charges is much larger than that for outpatients—extending up to approximately $70,000. FIG. 5 illustrates that the average charge plus the one-sigma standard deviation corresponds (approximately) to the 95th-percentile in terms of charges, further indicating that the sub-sample of patients provides a good approximation for the overall test group.

The methodology of the preferred embodiment of the invention thus employs patient financial information available from standard patient accounting data for clinical decision support (CDS), and has a wide degree of application. As illustrated in the examples shown above, the invention may be used by a physician to examine clinical information to determine the likelihood that a given patient will be admitted to a healthcare facility, which typical age populations are associated with those admissions, and the anticipated charges associated with inpatients and outpatients. This information is very valuable for evaluating whether a physician is charging according to standard diagnoses (to determine whether or not a patient represents an extreme case), and also for quality control purposes.

Those of ordinary skill in the art will appreciate that the possible uses for the invention also include physician review of orders written on patients to ascertain the appropriateness of new orders or of similar treatments for specific classes of patients, and quality control review of patients to ascertain whether diagnostic treatment they are receiving is consistent with approaches normally taken by physicians from around the United States. This methodology may also be expanded to support disease management of chronically ill patients by providing a historical record of treatment of patients experiencing respiratory ailments (ARDS, COPD), hypertension, arthritis, diabetes, etc. Home care agencies could employ this methodology as an adjunct to home care treatment as an aid to the patient by providing a means of determining whether charges are fair and accurate for specific treatments, or whether a patient is receiving the full measure of treatment for a specific chronic illness.

Although this invention has been described with reference to particular embodiments, it will be appreciated that many variations may be resorted to without departing from the spirit and scope of this invention as set forth in the appended claims. For example, while the invention has been described in the context of the clinical analysis of a patient, the invention may be applied to any number of investigative processes, such as administrative management of orders (retail, wholesale); law (case and claims management); political consulting (poll-based statistics); and any other fields requiring an understanding of historical data and its potential impact on effecting change or managing events based on this historical data. Also, while one apparatus has been disclosed herein, those of ordinary skill in the art will appreciate that any software/hardware system that is capable of performing in accordance with the invention may be used.

What is claimed is:

1. A method using a repository of patient medical records in supporting clinical decision-making, comprising the steps of:
receiving, from a first source, data representing an order associated with treatment of a medical condition;
interpreting said order to determine search criteria for use in identifying records related to said patient medical condition;
searching a database of patient medical records based on said search criteria;
identifying, in said patient medical record database, information concerning different treatments previously employed for treating said medical condition based on said search criteria; and
providing said different treatment information to said first source.

2. A method according to claim 1, wherein said information concerning different treatments includes resource consumption characteristic information concerning said different treatments and including the step of comparing resource consumption characteristics concerning treatment for a particular patient with corresponding resource consumption characteristics for said different treatments.

3. A method according to claim 1, wherein said resource consumption characteristics include at least one of (a) financial cost of a treatment or course of treatment, (b) quantity of medicine, (c) number of nursing hours, (d) number of physician hours, (e) cost of equipment usage, (f) length of time equipment used, (g) length of time of inpatient stay, (h) duration of home care facility usage (i) cost of medicine.

4. A method according to claim 1, wherein said order associated with treatment of said medical condition comprises a physician initiated order including at least one of (a) an order for a medical test to be made for a patient, (b) an order for a pharmacological prescription for a patient, (c) an order for a service to be performed for a patient, (d) an order for a form of diagnostic imaging to be performed for a patient, (e) an order for surgical treatment for a patient and (f) an order for a form of physiological therapy to be performed on a patient.

5. A method according to claim 1, wherein said patient medical record database contains statistically analyzed and trend indicative accumulated medical parameter information associated with a plurality of medical conditions and collated according to patient type characteristics.

6. A method according to claim 1, further comprising the step of initiating formatting and display of said different treatment information via a reproduction device.

7. A method according to claim 1, further comprising the step of storing data in said database comprising at least one of (a) patient treatment information and (b) a record of an order, together with an associated date, said data being collated by treatment and diagnosis category to accumulate patient medical records for a population of patients.

8. A method according to claim 1, further comprising the steps of:
identifying, in said patient medical record database, a previous order and associated date based on said search criteria;
determining a difference between said identified previous order and said received order associated with treatment of said medical condition; and
providing information indicating said order difference to said first source.

9. A method according to claim 1, further comprising the step of analyzing said different treatment information to determine a difference in at least one of, (a) diagnosis and (b) treatment associated with said order and corresponding previous diagnoses and treatments recorded for similar patients.

10. A system using a repository of patient medical records in supporting clinical decision-making comprising:
an interface processor for receiving, from a first source, data representing an order associated with treatment of a medical condition;
a database of patient medical records; and
a data processor for interpreting said order to determine search criteria for use in identifying records related to said patient medical condition and for initiating search of said database of patient medical records based on said search criteria to identify information concerning different treatments previously employed for treating said medical condition based on said search criteria and providing said different treatment information to said first source.

11. A system using a repository of patient medical records in supporting clinical decision-making, comprising:
an interface processor for receiving, from a first source, data representing an order associated with treatment of a medical condition;
a database of patient medical records; and
a data processor for interpreting said order to determine search criteria for use in identifying records related to said patient medical condition and for initiating search of said database of patient medical records based on said search criteria to identify resource consumption characteristic information concerning treatment previously employed for treating said medical condition based on said search criteria and providing said resource consumption information to said first source.

12. A system according to claim 11, wherein said data processor compares resource consumption characteristics concerning said treatment of said medical condition for a particular patient with corresponding identified resource consumption characteristic information concerning treatment previously employed for treating said medical condition.

13. A system according to claim 11, wherein said identified resource consumption characteristic information concerning treatment previously employed for treating said medical condition comprises statistically analyzed and trend indicative consumption characteristic information.

14. A system according to claim 11, wherein said resource consumption characteristic information includes at least one of (a) financial cost of a treatment or course of treatment, (b) quantity of medicine, (c) number of nursing hours, (d) number of physician hours, (e) cost of equipment usage, (f) length of time equipment used, (g) length of time of inpatient stay, (h) duration of home care facility usage (i) cost of medicine.

15. A method for supporting clinical decision-making comprising the steps of:
receiving patient training data for a plurality of patients;
computing statistics for said patient training data;
creating at least one regression model using said patient statistics;
receiving patient test data for at least one test patient, said patient test data having diagnosis data; and
comparing said test data with said regression models using said diagnosis data.

16. The method of claim 15, further comprising the step of generating a report of said comparison for displaying on a user interface.

17. An apparatus for supporting clinical decision-making comprising:
an interface processor for receiving patient training data for a plurality of patients and patient testing data for at least one test patient, said patient test data having diagnosis data;
a data processor in communication with said interface processor and programmed for computing statistics for said patient training data; creating at least one regression model using said patient statistics; and comparing said test data with said regression models using said diagnosis data.

18. The apparatus of claim 16, further comprising a data repository for storing one or more items selected from the group consisting of said patient training data, said patient testing data, said statistics, said regression model, and said comparison.

19. The apparatus of claim 17, wherein said interface processor is programmed to interact with a user interface to enable user control of said data processor.

20. In a healthcare patient administration system, a user interface for use in supporting clinical decision making comprising at least one interactive display image programmed for user determination of data from a first source, said data representing an order associated with treatment of a medical condition; interpreting said order to determine search criteria for use in identifying records related to said patient medical condition; searching a database of patient medical records based on said search criteria; identifying, in said patient medical record database, information concerning different treatments previously employed for treating said medical condition based on said search criteria; and providing said different treatment information to said first source.
